(19) United States
(12) Patent Application Publication
(10) Pub. No.: US 2022/0010492 A1
(43) Pub. Date: Jan. 13, 2022

(54) SURFACE TREATMENT COMPOSITION

(71) Applicant: Stora Enso OYJ, Helsinki (FI)

(72) Inventors: Nina Miikki, Imatra (FI); Kaj Backfolk, Lappeenranta (FI)

(73) Assignee: Stora Enso OYJ, Helsinki (FI)

(21) Appl. No.: 17/293,587

(22) PCT Filed: Oct. 29, 2019
(86) PCT No.: PCT/IB2019/059266

§ 371 Date: May 13, 2021

(30) Foreign Application Priority Data
Nov. 14, 2018 (SE) 1851421-6

(51) Int. Cl. D21H 19/58; D21H 21/54; B41M 5/52; D21H 21/16

(52) U.S. Cl. CPC D21H 19/58; D21H 21/16; B41M 5/5254; D21H 21/54

(57) ABSTRACT

A surface treatment composition comprising nanocellulose—such as microfibrillated cellulose (MFC)—and particles is provided. The particles comprise a supporting material and an active material comprising a salt of a multivalent metal. Various products comprising such a surface treatment composition and methods using said compositions are also provided.

The present invention relates to a surface treatment composition intended for the coating or sizing of paper, paperboard or other fibrous webs for example for use in ink-jet or flexographic printing, and for manufacturing a packaging material and a packaging material made by the method.

### BACKGROUND

Inkjet printing places high demands on the substrate to be printed, such as paper or paperboard. When using inkjet printing, the ink must be quickly dried and yet provide a high print quality. In the art, the application of multivalent salts (with the coating or surface sizing or by spraying) to the surface has shown to provide enhanced print quality since the ink will immobilize rapidly on the surface. One problem with the addition of salts to coating and/or sizing compositions is that they may cause rheology problems not only during mixing but also during application and levelling of the coating and undesired precipitations, especially when adding high amounts of salts.

WO2011098973 provided a solution to this problem by providing a coating composition comprising particles, which particles comprise salt of a multivalent metal and a supporting material including wax, wherein the salt is released from the supporting material when subjected to triggers such as heat, change in pH or pressure. In this process, the particles are applied to the surface of the paper/paperboard in the form of a colloidal dispersion.

One problem with the process disclosed in WO2011098973 is that the system (colloidal dispersion) in some cases requires stabilizers, dispersion aids and/or rheology modifiers. Typical stabilizers and rheology modifiers used in the art are, however, not always compatible with the salt or the wax included in the system. Such typical aids are oftentimes strongly anionic or amphoteric and might flocculate the salt cations.

WO2015136493 relates to a polymer extrusion coated or laminated paperboard material, suitable for packaging of e.g. foods or liquids, which paperboard material has excellent barrier properties, good adhesion between the base board and the polymer layer and good print quality. This is achieved by treating at least one surface of a paperboard substrate, which substrate comprises cellulosic fibres, with a binder and with a metal salt, printing at least a part of said treated surface with ink, and applying at least one polymer layer on said printed surface.

Advantages of the present technology may include one or more of improved print accuracy, wicking and bleeding (decreased), improved ink drying time, maintained or improved print density, good runnability, improved shear stability (coating/sizing composition), improved electrolyte stability, less coagulation, better broke handling and/or good coating quality.

### SUMMARY

In a first aspect, a surface treatment composition comprising nanocellulose and particles, which particles comprise a supporting material and an active material comprising a salt of a multivalent metal, is provided.

In another aspect, a process for the manufacture of a surface treated fibrous web comprising the following steps:

a) forming a fibrous web from pulp, and b) coating or surface sizing the fibrous web with at least one layer, wherein the fibrous web is coated or surface sized with a surface treatment composition as described herein, is provided.

In another aspect, a process for the manufacture of a printed fibrous web comprising above steps (a)-(b), followed by the step of: (d) printing the coated or surface sized fibrous web by use of inkjet and/or flexographic printing techniques is provided.

In another aspect, a paper or board product comprising a surface treatment composition as described herein, is provided.

In yet another aspect, a process of manufacturing a packaging material comprising the steps of: providing a paperboard substrate, comprising cellulosic fibres, treating at least one surface of said substrate with a surface treatment composition as described herein, printing at least a part of said treated surface with ink, and applying at least one polymer layer on said printed surface, is provided.

In yet another aspect, a paper or board product comprising a paper or board product substrate and a surface treatment composition as described herein as an innermost layer, optionally further comprising an aqueous based ink printed on at least a part of said innermost layer and optionally further comprising a thermoplastic polymer layer applied on said printed innermost layer, is provided.

In yet another aspect, a printed paper or board product comprising a surface treatment composition as described herein, preferably printed using an ink-jet or flexographic printer, is provided.

Further details of the technology are presented in the following description and embodiments and the dependent claims.

### LEGENDS TO THE FIGURES

FIG. 1 shows a comparison of black colour densities in single colour printing of paper having 3 different coatings (sample 1, sample 2 and sample 3 as described in example 1) and a reference using uncoated BergaJet paper.

FIG. 2 shows the optical density of paper having 3 different coatings (sample 1, sample 2 and sample 3 as described in example 1) and uncoated woodfree inkjet paper “Ref. Copypaper Colorlok). K100=black printed area with 100% ink coverage; C100=cyan printed area with 100% ink coverage; M100=magenta printed area with 100% ink coverage; Y100=yellow printed area with 100% ink coverage.

FIG. 3 shows graininess and FIG. 4 shows mottle on paper having 3 different coatings (sample 1, sample 2 and sample 3 as described in example 1), and uncoated woodfree inkjet paper “Ref. Copypaper Colorlok.

FIG. 5 shows line width and FIG. 6 shows line raggedness on paper having 3 different coatings (sample 1, sample 2 and sample 3 as described in example 1), and uncoated woodfree inkjet paper “Ref. Copypaper Colorlok.

### DETAILED DISCLOSURE

Described herein is a surface treatment composition comprising a) nanocellulose such as microfibrillated cellulose (MFC); and b) particles, which particles comprise a supporting material and an active material comprising a salt of a multivalent metal. It has been found by the present inventors that the use of nanocellulose such as microfibrillated cellulose (MFC) may improve the ink drying time and print accuracy (inks do not bleed into each other) and that the concentration of particles as defined herein can be lower when nanocellulose is present with the same print quality obtained.

As used herein, the term “surface treatment composition” relates to a coating or a surface sizing composition or the like.

a. Nanocellulose

Nanocellulose is a term referring to nano-structured cellulose. This may be either cellulose nanofibers (CNF) also called microfibrillated cellulose (MFC), nanocrystalline cellulose (NCC or CNC), or bacterial nanocellulose, which refers to nano-structured cellulose produced by bacteria

Microfibrillated cellulose (MFC) shall in the context of the patent application mean a nano scale cellulose particle fiber or fibril with at least one dimension less than 100 nm. MFC comprises partly or totally fibrillated cellulose or lignocellulose fibers. The liberated fibrils have a diameter less than 100 nm, whereas the actual fibril diameter or particle size distribution and/or aspect ratio (length/width) depends on the source and the manufacturing methods.

The smallest fibril is called elementary fibril and has a diameter of approximately 2-4 nm (see e.g. Chinga-Carrasco, G., Cellulose fibres, nanofibrils and microfibrils: The morphological sequence of MFC components from a plant physiology and fibre technology point of view, Nanoscale research letters 2011, 6:417), while it is common that the aggregated form of the elementary fibrils, also defined as microfibril (Fengel, D., Ultrastructural behavior of cell wall polysaccharides, Tappi J., March 1970, Vol 53, No. 3.), is the main product that is obtained when making MFC e.g. by using an extended refining process or pressure-drop disintegration process. Depending on the source and the manufacturing process, the length of the fibrils can vary from around 1 to more than 10 micrometers. A coarse MFC grade might contain a substantial fraction of fibrillated fibers, i.e. protruding fibrils from the tracheid (cellulose fiber), and with a certain amount of fibrils liberated from the tracheid (cellulose fiber).

There are different synonyms for MFC such as cellulose microfibrils, fibrillated cellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregrates and cellulose microfibril aggregates. MFC can also be characterized by various physical or physical-chemical properties such as large surface area or its ability to form a gel-like material at low solids (1-5 wt %) when dispersed in water. The cellulose fiber is preferably fibrillated to such an extent that the final specific surface area of the formed MFC is from about 1 to about 300 m²/g, such as from 1 to 200 m²/g or more preferably 50-200 m²/g when determined for a freeze-dried material with the BET method.

Various methods exist to make MFC, such as single or multiple pass refining, pre-hydrolysis followed by refining or high shear disintegration or liberation of fibrils. One or several pre-treatment steps are usually required in order to make MFC manufacturing both energy efficient and sustainable. The cellulose fibers of the pulp to be supplied may thus be pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxydation, for example “TEMPO”), or quaternary ammonium (cationic cellulose). After being modified or oxidized in one of the above-described methods, it is easier to disintegrate the fibers into MFC or nanofibrillar size fibrils.

The nanofibrillar cellulose may contain some hemicelluloses; the amount is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, single- or twin-screw extruder, fluidizer such as microfluidizer, macrofluidizer or fluidizer-type homogenizer. Depending on the MFC manufacturing method, the product might also contain fines, or nanocrystalline cellulose or e.g. other chemicals present in wood fibers or in papermaking process. The product might also contain various amounts of micron size fiber particles that have not been efficiently fibrillated.

MFC is produced from wood cellulose fibers, both from hardwood or softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or chemi-mechanical pulps. It can also be made from broke or recycled paper.

The above described definition of MFC includes, but is not limited to, the new proposed TAPPI standard W13021 on cellulose nanofibril (CNF) defining a cellulose nanofiber material containing multiple elementary fibrils with both crystalline and amorphous regions.

In one aspect, the nanocellulose is selected from the group consisting of native microfibrillated cellulose, nanocrystalline cellulose, chemically derivatized nanocrystalline cellulose and chemically derivatized microfibrillated cellulose; or a combination of any one or more of these.

“Native microfibrillated cellulose” is preferably made from pulp such as kraft or dissolving pulp. The pulp can be enzyme treated or hydrolyzed modified etc. in order to facilitate fibrillation, however, it is not derivatized.

“Nanocrystalline cellulose” is typically made by strong hydrolysis in acid medium such as HCl or H₂SO₄.

Examples of chemically derivatized microfibrillated cellulose are cellulose obtained by for example N-oxyl mediated oxidation for example “TEMPO”, phosphorylated microfibrillated cellulose or acetylated microfibrillated cellulose.

b. Particles Comprising a Supporting Material and an Active Material Comprising a Salt of a Multivalent Metal

The composition disclosed herein comprises particles which comprise an active material and a supporting material. The active material comprises a salt of a multivalent metal, such as a divalent or trivalent metal. In one embodiment the salt used is a metal salt such as CaCl₂) or MgCl₂. In accordance with the invention, the supporting material is adapted to release the active material from the particles when subjected to heat and/or pressure and/or a change in pH. In this way, the active material may be “trapped” in the particles at least until the composition is applied on the surface of the fibrous web and activated or stimulated in a later stage in the paper-making process. Consequently, the active material's adverse effects on the rheology of the composition are avoided while its desired effects on the surface characteristics are retained or enhanced. The invention renders it possible to dose a higher concentration of multivalent metals to a sizing or a coating composition without effecting the colloidal stability and hence the rheology of the composition negatively. In this way, the printability of the sized or coated paper or board can be improved. Moreover, use of the particles also reduces the concentration of the free anion of the multivalent salt, e.g. a chloride ion, in the composition whereby the risk of corrosion is reduced. In an embodiment of the invention, the multivalent metal salt is calcium chloride.

The active material may alternatively or additionally comprise at least one acid, such as citric acid, per acetic acid, hydrochloric acid or phosphoric acid. In this way, components, such as calcium carbonate, which do not normally comply with low pH, can be used while the benefits of low pH on the printing quality still can be obtained. In one embodiment, the active material comprises a monovalent or a multivalent salt and an acid. In this way, the print quality may be further improved, since the pH reduction and the salt have dual effect on the printing quality.

The supporting material of the particles may be selected from the group consisting of waxes, such as polyethylene waxes, propylene waxes, carnauba wax, micro wax, triglycerides, PEG, metal soaps, and co-polymers of styrene/acrylate or styrene/butadiene and a combination of any of these. Preferably, the supporting material of the particles is inert and water-resistant, or has a pre-determined solubility rate.

The supporting material may be sensitive to heat and may have a melting point or a glass transition point between 60-180° C., such as between 70-180° C., preferably between 70-110° C. When having a melting or a glass transition point within these intervals, the supporting material can be melted or formed/shaped in the drying or calendering of the fibrous web formed by surface treating a web with the composition, whereby the active material may be released from the particles in the drying or calendering section and bloomed to the surface of the web.

The supporting material may alternatively or additionally be sensitive to a pH change. The supporting material may, e.g. be dissolved when subjected to a low pH, such as at a pH below 7, or preferably between 5 and 7. A supporting material that is sensitive to pH could, e.g., be selected from the group of methyl acrylate-methacrylic acid copolymers, cellulose acetate succinate, hydroxyl propyl methyl cellulose phthalate, hydroxyl propyl methyl cellulose acetate succinate, hypromellose acetate succinate, polyvinyl acetate phthalate (PVAP), methyl methacrylate-methacrylic acid copolymers, sodium alginate or stearic acid or mixtures of the above. Stearic acid is an example of a supporting material that is sensitive to both low pH and high temperatures.

The particles may comprise a core comprising the active material, which core is encapsulated in a shell comprising the supporting material. By creating a core-shell structure, more defined particle morphology and better stability in the suspension can be obtained. The shell may be made of the supporting material, e.g. of a co-polymer of styrene/acrylate, which is melted, dissolved or destroyed when subjected to heat and/or pressure and/or a change in pH whereby the material within the core may be released from the particle. The core may comprise the active material in a bonded or in a separate form. The active material may e.g. be particulate, crystalline salt. Alternatively, the core may be a composite of the active material and a binding material. The binding material may be selected from the group consisting of waxes, such as polyethylene waxes, polypropylene waxes, triglycerides and metal soaps. The binding material may have a melting point between 60-180° C., such as between 70-180° C., preferably between 70-110° C. The melting point of the binding material may be similar or the same as that of the supporting material. The core may further comprise surfactants and/or chelating agents.

The supporting material may further comprise dispersed finely divided particles of an acid, such as citric acid, per acetic acid, hydrochloric acid or phosphoric acid. In one embodiment, the particles are of a core/shell construction and the core comprises a mono- or multivalent salt as an active material and the cell comprises dispersed finely divided particles of an acid. In this way, both an acid and a salt can be added to a coating/sizing composition that normally is not compatible with low pH and/or a metal salt. When the supporting material is melted, dissolved or destroyed, after the composition is applied on a fibrous web, the acid is released causing a pH reduction whereby the printability is improved. Simultaneously, the salt is released whereby the printability is further improved.

In one embodiment the particles are composites of a supporting material and an active material. Such a composite particle may, e.g., be formed of a multivalent metal salt as the active material and calcium stearate as the supporting material. The proportions between metal salt and wax may be in the range of 1:0.1-1:100. The wax used in the example comprises palmitic and stearic acid, but the use of other fatty acids or waxes and mixes thereof are also contemplated.

The particles may comprise the active material, e.g. the multivalent metal salt, to an amount of at least 30 wt %, such as in the range of 40-70w %, or in the range of 70-80w %. In this way, the composition may comprise a high concentration of the active material. Thus, the particles may be added to e.g. coating compositions without causing colloidal destabilization.

The particles may be prepared by different mixing and milling methods such as ball mill, hammer mill, conical mills etc. During the grinding, the temperature may be increased to above 40° C., such as above 60° C. and less than 250° C. In one preferred preparation step, the salt is first grinded and the supporting material (e.g. wax) is melted. The grinded salt and the melted wax is thereafter mixed and heavily stirred followed by cooling whereby the functional particles are formed. Further additives can be added during the milling or mixing such as polymer, anti-static agents, anti-coagulants, stabilizing agents, humectants etc. These can e.g. be sprayed or added dry. The particles are further fractionated or classified depending on the manufacturing process and type of recipes. The mean particle size can be 0.1-1000 μm. The particles can be added to the coating formulation in dry form or as wet dispersion.

The supporting material may be adapted to release the active material from the particles in a subsequent step on the paper machine after the composition has been applied to a surface of a fibrous web. The supporting material may, e.g., be adapted to release the active material in the subsequent drying or calendering of the web. Alternatively, the supporting material may be adapted to release the active material in a printing press at the printing of a paper or board formed.

The particles may further comprise at least one stabilizer, such as a surfactant or a hydrocolloid. The stabilizer should be selected so that it is compatible with the charge of the other coating or sizing components in the composition. If, e.g., the composition comprises anionic components, the stabilizer should preferably be neutral, amphoteric or anionic.

The present invention is especially advantageous when adding salts of multivalent metals to surface treatment compositions that are anionically charged, since such compositions are especially sensitive to multivalent ions, even at small concentrations.

The particles' average spherical diameter may be between 100-0.01 μm, preferably between 50-0.1 μm and even more preferably between 10-0.5 μm or between 1-5 μm, or 0.5-1.5 μm. A particle with a spherical diameter within these intervals has about the same size as a pigment particle and would therefore not cause any rheological problems or coating defects in e.g. film press or blade coating.

The surface treatment composition comprises particles that comprise high concentrations of active materials, which active materials are released from the particles in a controlled manner after the composition has been applied on the surface of a web. Use of such particles in the composition decreases rheology and viscosity problems that are connected with prior art compositions comprising as high concentrations of the active materials as the compositions described herein. Consequently, higher concentrations of the active materials may be used without causing rheology or viscosity problems.

By the expression “release . . . from the particles” as used herein means that the active material is transformed from a state wherein it is held within or in another way being a part of a particle to a state wherein the active material is not a part of a particle form, but in contact with the surface of the web. Thus, the active material might be released from the particle as a separate material, or it might be released from the particle in a bonded form, e.g. bonded or in another way attached to the supporting or binding material.

The technology is especially advantageous when dosing salt of multivalent ions to sizing composition, especially to anionically charged sizing composition, in order to enhance the inkjet printability of a paper or board. Said salts may e.g. be calcium chloride, aluminum chloride, magnesium chloride, magnesium bromide, calcium bromide, barium chloride, calcium nitrate, magnesium nitrate, barium nitrate, calcium acetate, magnesium acetate or barium acetate. Said anionic sizing composition may e.g. comprise anionic rosin soap sizing agents, anionic polymeric styrene maleic anhydride sizing agents or polyaluminum chloride.

The particles can be of a shell/core construction, with the active material being encapsulated as a core within a shell of a supporting material. Such particles can be manufactured using e.g. an emulsion polymerization method.

Alternatively, the particles may be of a composite construction, comprising a mixture of the active material and the supporting material. For example, instead of forming as shell/core structure, the particles may be a composite of a calcium stearate and calcium chloride. Such a particle may comprise calcium to an amount of 50 weight % or more. A calcium stearate/calcium chloride particle may be formed by mixing calcium stearate with calcium chloride, in a batch process. The formed particles are thereafter stabilized by use of e.g. starch and surfactants.

The particles may also be formed by e.g. dry blending calcium stearate and calcium chloride whereupon the mixture is milled and finally fractionated. The particles can then be stabilized in solution by using the said stabilizing system.

The composite materials can also be created using a spinning method, such as wet spinning, electrospinning or electrospraying. In such a method, a water soluble wax is, e.g., blended with calcium chloride and then spun. The temperature of the solution should preferably be above the melting point of the supporting or binding material, e.g. wax, in order to ensure solubility and blendability with the added components. The materials can be spun or sprayed (particulates) directly onto a substrate or indirect onto another collector plate, or alternatively, into a solution.

Other Components of the Surface Treatment Composition

The surface treatment composition described herein may further comprise other components commonly used in coating or sizing compositions. The composition may, e.g., further comprise cationic polymer, such as starches, carboxymethylcellulose (CMC), polyvinyl alcohol (PVA), sizing agents commonly used, such as alkylketene dimer (AKD) or acrylic co-polymers. The composition may further comprise acid copolymers, such as methyl acrylate. In one embodiment, the surface treatment composition comprises starch.

In an embodiment, the surface treatment composition described herein is especially useful for surface treatment of offset paper for inkjet inks, both dye and pigment. In an embodiment, especially suitable for inkjet, the surface treatment composition described herein further comprises a cationic polymer, such as starch. In a further embodiment, the surface treatment composition described herein further comprises pigment. In yet a further embodiment, the surface treatment composition described herein further comprises both a cationic polymer, such as starch, and pigment.

In one embodiment, the surface treatment composition herein described comprises the particles, which particles comprises the supporting material and the active material, in an amount of 1-99 wt %, or preferably 1-30 wt % or 1-25 wt % or 5-25 wt % calculated on the dry amount of said composition. The surface treatment composition may further comprise inorganic pigments, such as calcium carbonate, preferably in an amount of e.g. 1-90 wt %, or 20-80 wt %, or 30-70 wt % based on the total dry amount of said composition. The surface treatment composition may further comprise binders, such as e.g. starch or latex, preferably in an amount of 1-90 wt %, or preferably 5-80 wt % or 5-30 wt % or 10-30 wt %. The surface treatment composition may further comprise nanocellulose in an amount of 0.1-30 wt %, preferably 0.1-20 wt %, most preferably 0.1-10 wt, calculated on the dry amount of said surface treatment composition.

In an embodiment, wherein the surface treatment composition described herein comprises starch, the amount of nanocellulose is 1-100 parts by weight based on the amount of starch.

In an embodiment, wherein the surface treatment composition described herein comprises starch, the amount of particles is 1-100 parts by weight based on the amount of starch.

In an embodiment, wherein the surface treatment composition described herein comprises starch and pigments, the amount of pigment is 1-500 parts by weight based on the amount of starch.

Coating

In an embodiment, the surface treatment composition is applied in a coat weight in the range of 1-20 g/m² or 1-15 g/m², wherein the coat weight refers to the whole coat weight including pigments, binders, and/or latex etc In another embodiment, the coat weight is smaller, e.g. in the range of 1-10 or 1-5 g/m² in order to—among other things—facilitate the drying time.

Paper or Board Product

The invention further relates to a paper or board product comprising the surface treatment composition described above and a printed paper or board comprising these products, preferably being printed by inkjet and/or flexographic printing techniques.

The printed paper or board comprising these paper or board products may preferably be printed with inkjet technique using water based pigmented inks.

The invention is, however, not limited to solely inkjet, but can further be used to improve print quality in e.g. flexography where water based dye or pigmented inks are used.

The technology is further applicable for hybrid printed products, in which one of the printing methods is based on pigmented water based inkjet inks. Moreover, the invention is also applicable for printing with hybrid inks, which here relates to inks containing both dye and pigment particles.

Packaging Material

The invention further relates to a packaging material comprising a paper or board product with a surface treatment composition as described herein as an innermost layer. The paper or board product may further comprise an aqueous based ink printed on at least a part of said innermost layer, and optionally a thermoplastic polymer layer applied on said printed innermost layer.

The packaging material produced in accordance with the invention shows good printability. It has been shown that paperboard substrates may be surface treated with the surface treatment composition as described herein and yet allow good adhesion of a polymer layer.

The invention further relates to a packaging material comprising; a paperboard substrate comprising cellulosic fibres, an innermost layer comprising a surface treatment composition as described herein, aqueous based ink printed on at least a part of said innermost layer, and a polymer layer applied on said printed innermost layer.

The polymer layer may comprise a thermoplastic polymer. The polymer may, for example, comprise polyethylene (PE), polyethylene terephthalate (PET), polypropylene (PP) and/or polylactic acid (PLA) and/or biobased materials of any of these including modifications of the mentioned thermoplastics. The polymer may be applied to the printed surface by use of any known coating or film application technique, e.g. by extrusion coating. The polymer barrier coating layer can also be applied in one or several layers.

The invention further relates to a packaging material made by the process described herein. A packaging material in accordance with the invention is suitable for packaging of e.g. dry or liquid food, cosmetic or pharmaceuticals.

By “paperboard substrate comprising cellulosic fibres” is meant a base paperboard with a grammage of at least 100 gsm or at least 150 gsm, more preferably of at least 180 gsm, comprising fibres from unbleached or bleached pulp which can be chemical pulp such as sulfate, kraft, soda or sulfite pulp, mechanical pulp, high refined pulp (MFC), thermomechanical pulp or chemi-thermomechanical pulp and the raw material can be based on softwood, hardwood, recycled fibres or non-wood suitable for making paperboard. Preferably, the paperboard substrate is a multilayer paperboard substrate comprising at least two plies, such as three plies; e.g. a top ply, a back ply and a middle ply. The paperboard substrate may be surface sized on the surface of the top ply with e.g. starch and additives including pigmentation. Also the back ply may be surface sized and/or, pigmented or single or double coated.

In the context of this application, the term “innermost” means that the layer is applied directly on the paperboard substrate.

The ink used in the invention comprises pigments, or pigments and dyes, and may be aqueous or solvent based, or a mixture of aqueous and (co-)solvent thus forming a suitable carrier medium for the ink particles. Preferably, the ink comprises anionic nanoparticles (as colorants). Preferably, the ink is printed by use of inkjet printing, thus most preferably high speed inkjet either reel to reel or sheet fed, but other printing techniques are also applicable, such as flexographic, offset, liquid toner electrophotography printing and/or hybrid printing meaning for example a combination of flexography and inkjet. The substrate may be provided with an additional primer layer before being printed with the ink comprising pigments. Such a primer layer may comprise salt or ink without pigments and can be applied with either normal flexography or rotogravure methods. Thus, an additional primer layer can also be applied with the high speed inkjet prior to deposition of the inkjet inks.

The packaging material of the invention may be provided with further barrier layers. The back ply may e.g. be provided with polymer barriers in one or several layers.

Processes

The invention further relates to a process for the manufacture of a surface-treated and printed paper or board, such as an inkjet or flexographic printed paper or board, or other fibrous webs. Said process comprises the steps of forming a fibrous web from pulp, and coating or surface sizing the fibrous web with at least one layer of the surface treatment composition of the invention. The surface sizing of the fibrous web may be applied at the drying section, e.g. in a size press, or at the wet end of the paper machine. The process further comprises the subsequent step of treating the fibrous web so that the active material is released from the particles on the surface of the fibrous web. This may be achieved in a subsequent step in the paper machine, e.g. at the drying or calendering of the surface-treated web or by changing the pH, e.g. by activating acids comprised in the composition by the application of heat. The process may further comprise the step of printing the resulting coated or surface sized paper or board by use of inkjet and/or flexographic printing techniques.

The invention further relates to a process for the manufacture of a packaging material comprising the steps of;
a. providing a paperboard substrate, comprising cellulosic fibres,
b. treating at least one surface of said substrate with a surface treatment composition as described herein,
c. printing at least a part of said treated surface with ink, and
d. applying at least one polymer layer on said printed surface.

The paperboard substrate may be surface sized on the surface of the top ply with e.g. starch and additives including pigmentation. Also the back ply may be surface sized and/or, pigmented or single or double coated. In one embodiment, the substrate is surface sized with starch and additives. In a further embodiment, the substrate is surface sized with starch and pigmentation. In a further embodiment, the surface treatment composition is applied to the surface in an amount of at least 0.1 g/m². In yet a further embodiment, the starch is applied to the surface in an amount of at least 0.1 g/m².

The surface treatment composition described herein may be applied to the surface of the paperboard substrate by use of any known application technique such as surface sizing, lamination or coating, including but not limited to, spraying, curtain coating, extrusion coating, film press coating or blade coating.

The polymer may be applied to the printed surface by use of any known coating or film application technique, e.g. by extrusion coating. The polymer barrier coating layer can also be applied in one or several layers.

### SPECIFIC EMBODIMENTS OF THE INVENTION

Embodiment 1. A surface treatment composition comprising nanocellulose—such as microfibrillated cellulose (MFC)—and particles, which particles comprise a supporting material and an active material comprising a salt of a multivalent metal.

Embodiment 2. The composition according to embodiment 1, wherein the amount of nanocellulose is 0.1-30 wt %, preferably 0.1-20 wt %, most preferably 0.1-10 wt % calculated based on the dry amount of surface treatment composition.

Embodiment 3. The composition according to any one of embodiments 1-2, wherein the composition is in the form of a dispersion.

Embodiment 4. The composition according to any one of embodiments 1-3, wherein the supporting material is adapted to release the active material from the particles when subjected to heat and/or a change in pH or when subjected to heat and pressure.

Embodiment 5. The composition according to any one of embodiments 1-4, wherein the active material comprises a calcium salt, such as calcium chloride.

Embodiment 6. The composition according to any one of embodiments 1-5, wherein the active material comprises an acid.

Embodiment 7. The composition according to any one of embodiments 1-6, wherein the supporting material is selected from the group consisting of waxes, such as polyethylene waxes, polypropylene waxes, triglycerides, metal soaps, and co-polymers of styrene/acrylate or styrene/butadiene or a combination of any of these.

Embodiment 8. The composition according to any one of embodiments 1-7, wherein the supporting material is sensitive to heat and has a melting point or a glass transition point of between 60-180° C., preferably of between 70-110° C.

Embodiment 9. The composition according to any one of embodiments 1-8, wherein the particles comprise a core comprising the active material, which core is encapsulated in a shell comprising the supporting material.

Embodiment 10. The composition according to embodiment 9, wherein the core comprises the active material and a binding material, and wherein the shell is made of the supporting material.

Embodiment 11. The composition according to embodiment 10, wherein the binding material is selected from the group consisting of waxes, such as polyethylene waxes, triglycerides, metal soaps, or co-polymers of e.g. styrene/acrylate or styrene/butadiene.

Embodiment 12. The composition according to any one of embodiments 1-11, wherein the particles comprises the active material in an amount of at least 50 weight %, preferably 75 weight %, most preferably 80 weight %.

Embodiment 13. The composition according to any one of the preceding embodiments, wherein the particles' spherical diameter is between 100-0.01 μm, preferably between 50-0.1 μm and most preferably between 10-0.5 μm.

Embodiment 14. The composition according to any one of embodiments 1-13, wherein the supporting material is adapted to release the active material when subjected to heat and/or pressure and/or change of pH.

Embodiment 15. The composition according to any one of embodiments 1-14, wherein the supporting material is adapted to release the active material during drying of a paper, board or fibrous web that has been surface treated with the composition.

Embodiment 16. The composition according to any one of embodiments 1-15, wherein the particles further comprise at least one stabilizer, such as a hydrocolloid and/or surfactants.

Embodiment 17. The composition according to any one of embodiments 1-16, wherein the composition is anionically, amphoterically, or nonionically charged.

Embodiment 18. The composition according to any one of embodiments 1-17, wherein the composition further comprises one or more cationic polymer such as starch, carboxymethylcellulose (CMC), polyvinyl alcohol (PVA), or a sizing agent, such as alkylketene dimer (AKD) or acrylic co-polymers.

Embodiment 19. The composition according to any one of the preceding embodiments, wherein the composition comprises starch.

Embodiment 20. The composition according to any one of the preceding embodiments, wherein the composition further comprises one or more rheology modifiers, pigments, colorants, dyes, crosslinkers or biocides.

Embodiment 21. The composition according to any one of the preceding embodiments, wherein the composition comprises pigments.

Embodiment 22. The composition according to any one of the preceding embodiments, wherein the composition comprises starch and pigments.

Embodiment 23. The composition according to any one of the preceding embodiments, wherein the composition comprises starch, and the amount of nanocellulose is 1-100 parts by weight based on the amount of starch.

Embodiment 24. The composition according to any one of the preceding embodiments, wherein the composition comprises starch, and the amount of particles is 1-100 parts by weight based on the amount of starch.

Embodiment 25. The composition according to any one of the preceding embodiments, wherein the composition comprises starch and pigments and the amount of pigment is 1-500 parts by weight based on the amount of starch.

Embodiment 26. The composition according to any one of the preceding embodiments, which composition is applied in a coat weight of 1-20 g/m² or 1-15 g/m².

Embodiment 27. A process for the manufacture of a surface treated fibrous web comprising the following steps:

a) forming a fibrous web from pulp, and

b) coating or surface sizing the fibrous web with at least one layer, wherein the fibrous web is coated or surface sized with a surface treatment composition as defined in any one of the preceding embodiments.

Embodiment 28. The process according to embodiment 27, further comprising the step of (c) releasing the active material from the particles on the surface of the fibrous web by the application of heat and/or pressure and/or a change of pH.

Embodiment 29. The process according to embodiment 28, wherein the step c) of releasing the active material from the particles is accomplished in the drying or in the calendaring of the fibrous web.

Embodiment 30. A process for the manufacture of a printed fibrous web comprising, steps (a)-(b) and optionally (c) of embodiments 27-29, followed by the step of: (d) printing the coated or surface sized fibrous web by use of inkjet and/or flexographic printing techniques.

Embodiment 31. A process according to any one of embodiments 27-30, wherein said fibrous web is paper or board.

Embodiment 32. The process according to any one of embodiments 27-31, wherein the composition is applied in a coat weight of 1-20 g/m² or 1-15 g/m².

Embodiment 33. A paper or board product comprising a surface treatment composition as defined in any one of embodiments 1-26.

Embodiment 34. A process of manufacturing a packaging material comprising the steps of;
a. providing a paperboard substrate, comprising cellulosic fibres,
b. treating at least one surface of said substrate with surface treatment composition as defined in any one of embodiments 1-26,
c. printing at least a part of said treated surface with ink, and
d. applying at least one polymer layer on said printed surface.

Embodiment 35. The process according to any one of embodiments 27-34, wherein the surface treatment composition as defined in any one of embodiments 1-19 is applied to the surface in an amount of at least 0.1 g/m².

Embodiment 36. The process according to any one of embodiments 27-35, wherein starch is applied to the surface in an amount of at least 0.1 g/m².

Embodiment 37. The process according to any one of embodiments 27-36, wherein the polymer layer comprises polyethylene (PE) and/or polyethylene terephthalate (PET), polypropylene (PP) and/or polylactic acid (PLA) and/or biobased materials of any of these.

Embodiment 38. A packaging material made by the process of any one of embodiments 27-37.

Embodiment 39. A paper or board product comprising a paper or board product substrate and a surface treatment composition as defined in any one of embodiments 1-26 as an innermost layer.

Embodiment 40. The paper or board product according to embodiment 39 further comprising an aqueous based ink printed on at least a part of said innermost layer.

Embodiment 41. The paper or board product according to any one of embodiments 39-40 further comprising a thermoplastic polymer layer applied on said printed innermost layer.

Embodiment 42. A printed paper or board product comprising a surface treatment composition as defined in any one of embodiments 1-26.

Embodiment 43. A printed paper or board product as defined in embodiments 41, which is printed using an ink-jet or flexographic printer.

Embodiment 44. Use of a surface treatment composition as defined in any one of embodiments 1-26, for treatment of a fibrous web to obtain a paper or board product for printing with ink having an improved ink drying time, print accuracy and/or coater runnability.

Embodiment 45. The use according to embodiment 44, wherein said printing is ink-jet or flexographic printing.

### EXAMPLES

### Example 1

In order to evaluate the surface treatment compositions as described herein, a test series were performed in which black colour densities in single colour printing with paper treated with below sample 3 was compared with a reference of paper coated with below sample 1, a reference of paper coated with sample 2 and a reference using uncoated BergaJet paper.

Base paper for sample 1, 2 and 3 was 120 g/m² uncoated paper from PM6 at Imatra Mills.

| Coating recipe | Sample 1 | Sample 2 | Sample 3 |
|---|---|---|---|
| CaCO₃ | 100 | 70 | 70 |
| Salt/wax particles* | | 30 | 30 |
| Polyvinyl alcohol (PVA) | 1 | 1 | 1 |
| Styrene Acrylic (SA) -latex | 18 | 18 | 18 |
| Zirconium potassium | 0.17 | 0.17 | 0.17 |
| carbonate based hardener | | | |
| Calsiumstearate | 0.3 | 0.3 | 0.3 |
| MFC | — | — | 0.8 |
| Coat weight, g/m² | 11 | 11 | 11 |
| pH | 8.4 | 4.9 | nd |
| Dry solids, % | 65 | 58 | 46 |
| Viscosity (Brookfield), mPas | 285 | 260 | nd |

The wax/salt particles were made in a dry granulate manufacturing process in accordance with the following:

15 kg CaCl₂) (Tetrachemicals: CC road 77%)

1.6 kg of stearic acid wax (Radiacid R 0436, Tallow based C16/C18 saturated)

The ratio of wax to metal salt is 1:10 (as received). The salt and wax was mixed in dry form and then milled in a hammer mill.

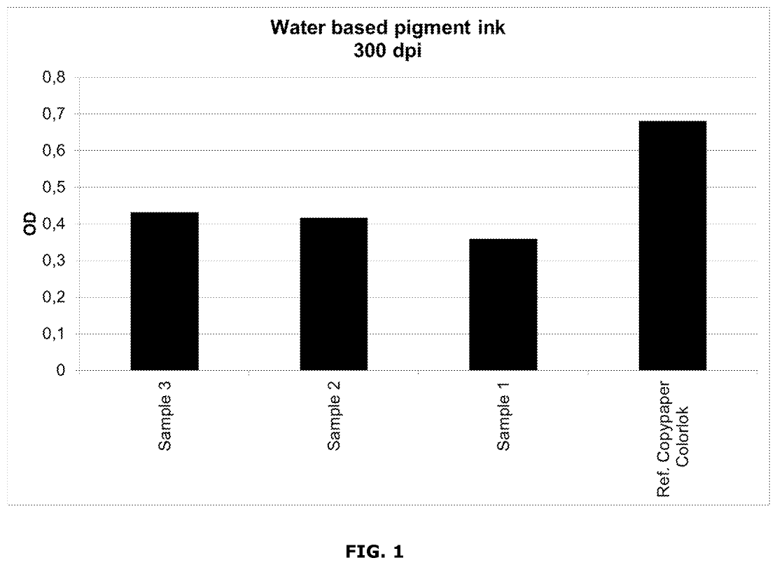

FIG. 1 shows the results of using different coatings and black colour densities in single colour printing.

### Example 2

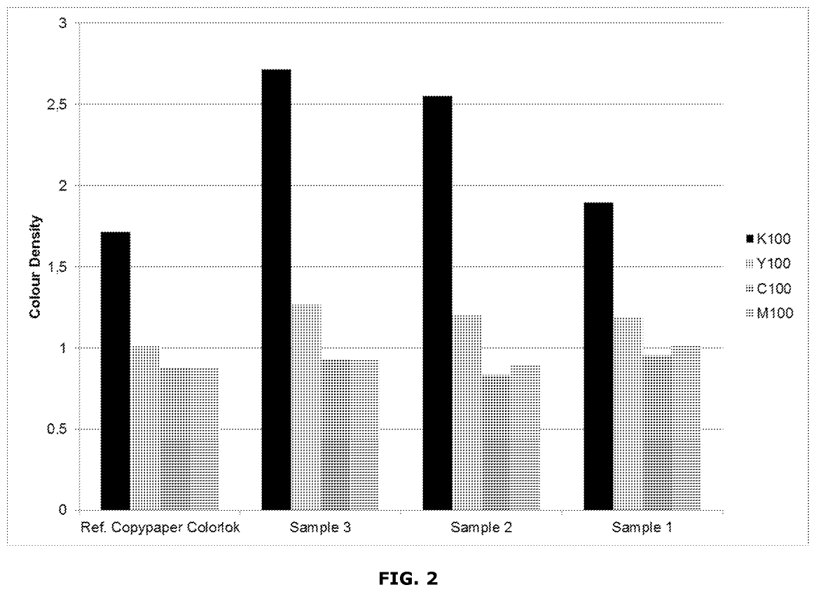

FIGS. 2, 3, 4, 5 and 6 show the results of four colour printing with a HP Officejet 6100—printer with normal settings and DPI:600 of paper with above three different coatings sample 1, sample 2 and sample 3, and copypaper Colorlok. The test image used is as shown in FIG. 2.

FIG. 2 shows optical density. “Optical Density” was measured DIN 16536. K100=black printed area with 100% ink coverage; C100=cyan printed area with 100% ink coverage; M100=magenta printed area with 100% ink coverage; Y100=yellow printed area with 100% ink coverage

“Graininess” and “Print mottle” are both a measure of non-uniformity.

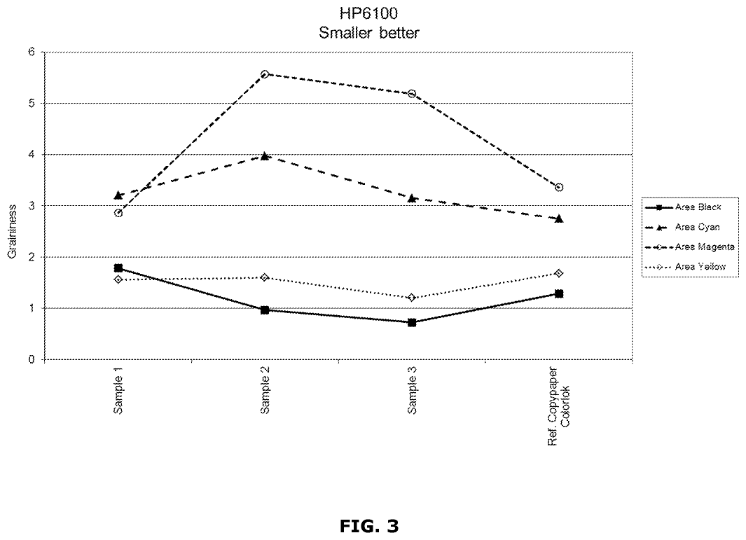

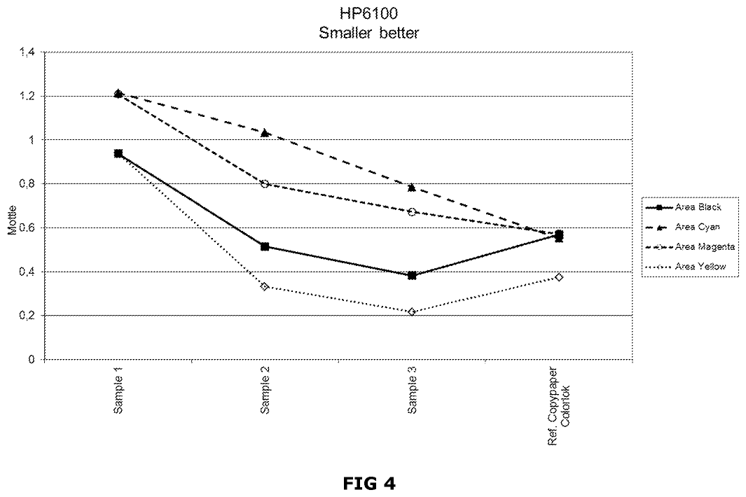

FIG. 3 shows “Print Mottle” and was measured in accordance ISO/IEC 13660.

FIG. 4 shows “graininess” and was measured in accordance ISO/IEC 13660.

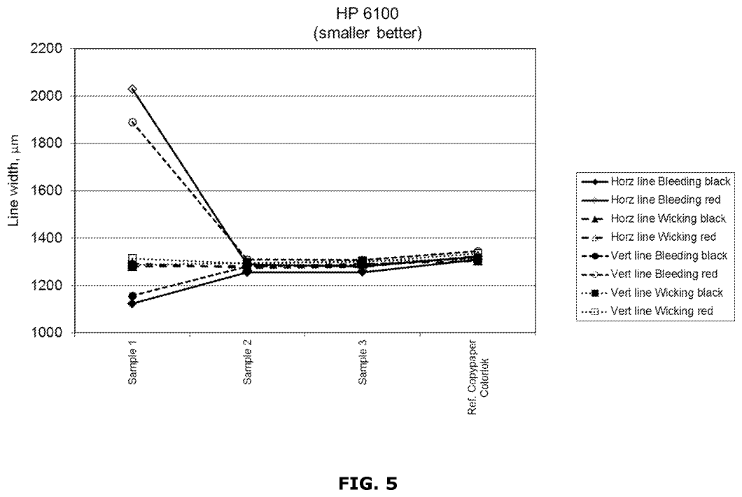

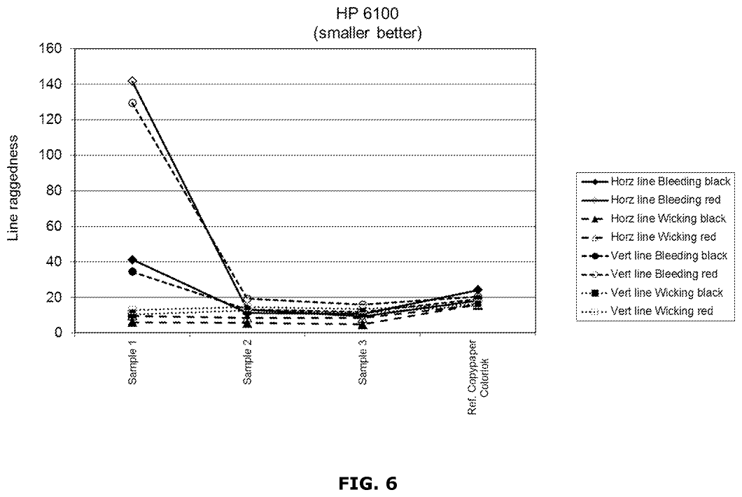

FIG. 5 shows “line width” and was measured in accordance ISO/IEC 13660.

FIG. 6 shows “line raggedness” and was measured in accordance ISO/IEC 13660.

1. A surface treatment composition comprising:
nanocellulose and particles,
wherein the particles comprise a supporting material and an active material comprising a salt of a multivalent metal.

2. The surface treatment composition according to claim 1, wherein an amount of nanocellulose is between 0.1-30 wt %, calculated based on a dry amount of surface treatment composition.

3. The surface treatment composition according to claim 1, wherein the nanocellulose is microfibrillated cellulose (MFC).

4. The surface treatment composition according to claim 1, wherein the active material comprises a calcium salt.

5. The surface treatment composition according to claim 1, wherein the supporting material is selected from a group consisting of: waxes, triglycerides, metal soaps, co-polymers of styrene/acrylate, co-polymers of styrene/butadiene, and combinations thereof.

6. The surface treatment composition according to claim 1, wherein the particles comprise a core comprising the active material, and wherein the core is encapsulated in a shell comprising the supporting material.

7. The surface treatment composition according to claim 6, wherein the core comprises the active material and a binding material, and wherein the shell is made of the supporting material.

8. The surface treatment composition according to claim 7, wherein the binding material is selected from a group consisting of: waxes, triglycerides, metal soaps, co-polymers of styrene/acrylate, and co-polymers of styrene/butadiene.

9. The surface treatment composition according to claim 1, wherein the particles comprise the active material in an amount of at least 50 weight %.

10. The surface treatment composition according to claim 1, wherein the particles comprise a spherical diameter between 100-0.01 μm.

11. The surface treatment composition according to claim 1, wherein the supporting material is configured to release the active material when subjected to heat, pressure, change of pH, or a combination thereof.

12. The surface treatment composition according to claim 1, further comprising:
one or more cationic polymers a sizing agent, or both.

13. The surface treatment composition according to claim 1, further comprising:
pigments.

14. The surface treatment composition according to claim 1, further comprising:
starch, and
wherein an amount of the particles is between 1-100 parts by weight based on an amount of starch.

15. The surface treatment composition according to claim 1, further comprising:
starch and pigments, and
wherein an amount of the pigments is between 1-500 parts by weight based on an amount of starch.

16. A process for the manufacture of a surface treated fibrous web comprising the following steps:
a) forming a fibrous web from pulp, and
b) coating or surface sizing the fibrous web with at least one layer, wherein the fibrous web is coated or surface sized with the surface treatment composition of claim 1, and
c) releasing the active material from the particles on the surface of the fibrous web by the application of heat, pressure, a change of pH or a combination thereof.

17. The process according to claim 16, wherein the step c) of releasing the active material from the particles is accomplished in a drying or in a calendaring of the fibrous web.

18. The process according to claim 16, further comprising the step of: (d) printing the coated or surface sized fibrous web by use of inkjet, flexographic printing techniques, or both, wherein said fibrous web preferably is paper or board.

19. The process according to claim 16, wherein the surface treatment composition is applied in a coat weight of between 1-20 g/m².

20. (canceled)

21. A process of manufacturing a packaging material comprising the steps of:
a. providing a paperboard substrate comprising cellulosic fibres,
b. treating at least one surface of said substrate with the surface treatment composition as defined in claim 1,
c. printing at least a part of said treated surface with ink to provide a printed surface, and
d. applying at least one polymer layer on said printed surface.

22.-23. (canceled)
